(19) United States
(12) Patent Application Publication
(10) Pub. No.: US 2008/0063427 A1
(43) Pub. Date: Mar. 13, 2008

(54) IMAGE FORMING DEVICE

(75) Inventors: Masaharu IKADO, Kyoto-shi (JP); Hideaki KAWAI, Kyoto-shi (JP)

Correspondence Address: MURATA MACHINERY, LTD.;(MURATEC) c/o KEATING & BENNETT LLP, 8180 GREENSBORO DRIVE, SUITE 850, MCLEAN, VA, 22102, US

(73) Assignee: MURATA MACHINERY, LTD., Fushimi-ku (JP)

(21) Appl. No.: 11/848,487

(22) Filed: Aug. 31, 2007

(30) Foreign Application Priority Data
Sep. 12, 2006 (JP) 2006-246741

(51) Int. Cl. G03G 15/08

(52) U.S. Cl. 399/106

(57) ABSTRACT

An image forming device includes a process unit, a toner containing portion, and a trapping member. The toner containing portion is arranged in relation to the process unit and connected to the process unit so as to define a toner transporting mechanism. The toner transporting mechanism includes a toner receiving/supplying portion having a toner receiving port and a toner supplying port such that the toner receiving port and the toner supplying port can be removably connected to each other. The trapping member is attached to a surface of a portion adjacent to the toner receiving/supplying portion and traps leaked toner.

### CROSS-REFERENCE TO RELATED APPLICATIONS

This application claims priority under 35 U.S.C. 119 to Japanese Patent Application No. 2006-246741, filed on Sep. 12, 2006, which application is hereby incorporated by reference in its entirety.

### BACKGROUND OF THE INVENTION

1. Field of the Invention

The present invention relates to an image forming device.

The image forming device includes an image forming process unit having a developing device, and includes a toner containing portion arranged in relation to the process unit. When the image forming process unit and the toner containing portion are connected, a toner transporting mechanism is established.

2. Description of the Related Art

An electrophotographic image forming device is frequently used in a copier, a facsimile machine, a printer, or a Multi Function Peripheral (MFP) having a copying function, a facsimile function, and/or a printing function. Some of these image forming devices use a developer including two components (toner and carrier). The image forming device includes an image forming process unit such as a developing device unit or a photoconductive drum unit, a toner supply hopper, and a waste toner collecting hopper. The toner supply hopper supplies the developing device unit with toner, if required. The waste toner collecting hopper collects the transferred residual toner. The image forming process unit, the toner supply hopper, and the waste toner collecting hopper can be separately inserted into a device main body. In the device main body, the image forming process unit, the toner supply hopper, and the waste toner collecting hopper are connected, and thus, a toner transporting mechanism is established. Moreover, the developing device unit and the photoconductive drum unit may be integrated to define the image forming process unit. Further, the toner supply hopper and the waste toner collecting hopper may also be integrated.

The above-described image forming device includes a toner receiving/supplying portion arranged within the toner transporting mechanism. A toner receiving port and a toner supplying port of the toner receiving/supplying portion can be removably connected to each other. At the toner receiving/supplying portion, since the toner is composed of microscopic particles, toner leakage cannot be completely prevented. Therefore, it is unavoidable that some of the toner leaks and accumulates in the vicinity of the toner receiving/supplying portion. The leaked and accumulated toner does not greatly matter under a normal use condition. However, when changing a toner container cartridge or each process unit, the accumulated toner may scatter due to oscillations and impacts occur on the device body. As a result, the toner is transferred and adhered to a mechanism portion, which affects the image quality, and the toner can stain the user's clothing or hands. The toner scatters for at least the following reason. Because the housing including the cartridge and the process unit is made of resin and metal, the toner accumulated on a surface of the housing is not fixed and can be easily detached by the oscillations and the impacts.

Conventionally, some developing devices include a shutter arranged above a developing portion of the developing device such that two-sided adhesive tape is adhered to a portion of the shutter facing an inside of the developing portion. The developing device is inserted to a prescribed portion inside the image forming device under a state in which the shutter is open, a surface to which the two-sided adhesive tape is adhered faces upward, and a release paper of the two-sided adhesive tape is peeled off. Under the above-described inserted state, an adhesive surface of the two-sided adhesive tape is exposed on an upper surface. Thus, paper scraps from a paper feed cassette arranged above the developing device can be trapped by the two-sided adhesive tape. Accordingly, when drawing out the developing device, the paper scraps will not scatter and stain a surrounding area.

Conventionally, the paper scraps from the paper cassette is trapped by the two-sided adhesive tape adhered to the shutter of the developing device. However, it is not an intention of the conventional art to trap the leaked toner. Moreover, it is not an intention of the conventional art to trap the leaked toner in order that the toner unavoidably accumulated in the vicinity of the toner receiving/supplying portion can be prevented from scattering. In particular, components for forming an image, such as the process unit or the toner cartridge, are changed as consumable components by a user. However, in a case in which the toner receiving/supplying portion is arranged on a front side in an inserting direction of the components with respect to the device, the toner leaked and accumulated in the vicinity of the toner receiving/supplying portion is scattered by oscillations and impacts generated when changing the components, and the leaked and accumulated toner can stain the user's hands or clothing.

### SUMMARY OF THE INVENTION

In order to overcome the problems described above, preferred embodiments of the present invention provide an image forming device in which toner leaked from a toner receiving/supplying portion arranged within a toner transporting mechanism is trapped and prevented from scattering.

In the image forming device according to a preferred embodiment of the present invention, an image forming process unit having a developing device and a toner containing portion arranged in relation to the process unit are connected to define a toner transporting mechanism. The toner transporting mechanism includes a toner receiving/supplying portion having a toner receiving port and a toner supplying port such that the toner receiving port and the toner supplying port are removably connected to each other. A trapping member arranged to trap leaked toner is attached to a surface of a portion adjacent to the toner receiving/supplying portion.

According to a preferred embodiment of the present invention, a shutter that is opened when the toner receiving/supplying portion is connected may be provided on a portion corresponding to the toner receiving/supplying portion in the toner transporting mechanism. Moreover, a trapping member preferably includes a porous member including a plurality of micro cells that can absorb toner particles therein. As the porous member, open-cell urethane foam is preferably used. Further, it is preferable that the image forming process unit and/or the toner containing portion are removably inserted into a device main body from a side portion of the device main body, and that the toner receiving/supplying portion is positioned on a front side in an inserting direction. The side portion includes front, rear, right, and left side portions.

In the image forming device according to a preferred embodiment of the present invention, since the trapping member for trapping the leaked toner is attached to the surface of the portion adjacent to the toner receiving/supplying portion, the leaked toner can be trapped and reliably held by the trapping member. Therefore, even when oscillations and impacts occur on the device, the leaked toner will not scatter. Accordingly, the image quality will not be affected, and hands and clothing of the user will not be stained.

When the shutter that is opened under the above-described connected state is provided on the portion corresponding to the toner receiving/supplying portion, the toner leakage from the toner receiving/supplying portion can be prevented before and after a connecting operation since the shutter is closed under the disconnected state. Moreover, when the trapping member includes the porous member having the plurality of micro cells that can absorb the toner particles therein, the toner, which is composed of microscopic particles, is absorbed into the micro cells, trapped, and fixed therein. For example, an open-cell urethane foam, which can be easily obtained and easily handled, is used as the porous member. Further, the image forming process unit and/or the toner containing portion is removably inserted into the device main body from the side portion of the device main body, and the toner receiving/supplying portion is positioned on the front side in the inserting direction. Therefore, when the user performs an inserting/removing operation of the process unit, concerns in which the hands and clothing of the user will be stained are reduced.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic longitudinal sectional view illustrating an image forming device according to a preferred embodiment of the present invention.

FIG. 2 is a schematic plan view illustrating a configuration of a toner transporting mechanism of the image forming device.

FIG. 3 is a cross sectional view taken on line Y-Y in FIG. 2.

FIGS. 4A, 4B, and 4C are schematic plan views illustrating operations carried out at a portion indicated by “Z” in FIG. 2.

### DETAILED DESCRIPTION OF PREFERRED EMBODIMENTS

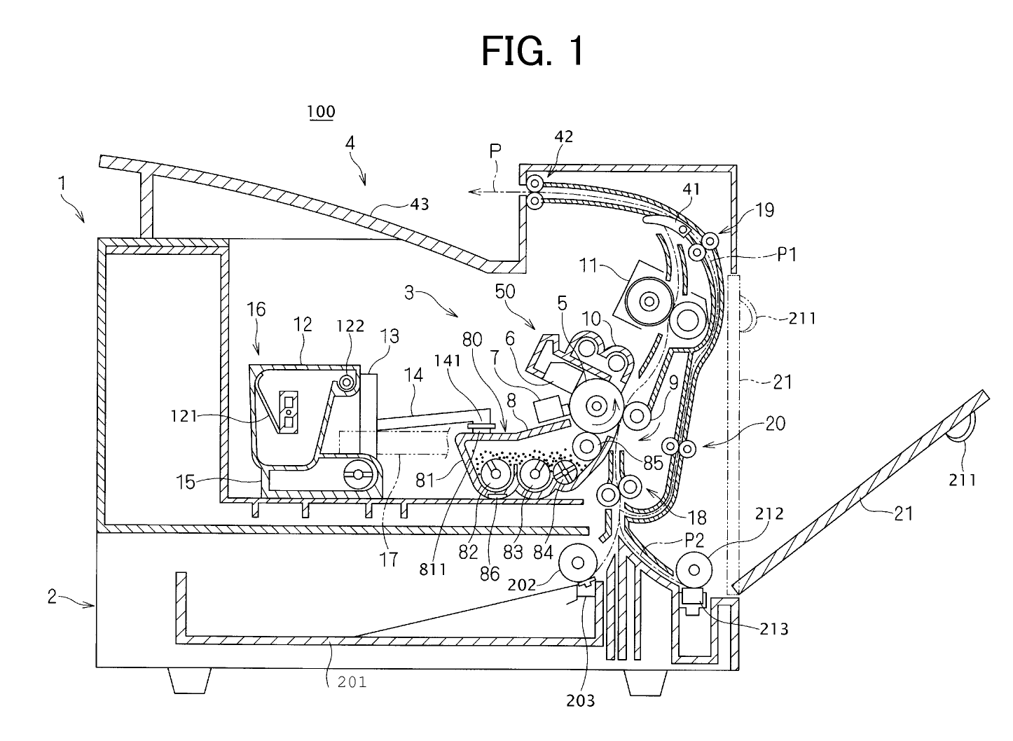

With reference to the drawings, description will be made of preferred embodiments of the present invention. An image forming device 100 in FIG. 1 is a printer, for example, including an electrophotographic recording unit. The present invention is not limited to such a printer, but may be a copier, a facsimile machine, or an MFP having a copying function, a facsimile function, and/or a printing function, and including an image scanning device. In FIG. 1, a device main body 1 of the image forming device 100 includes a paper feed unit 2 for recording papers, an electrophotographic image recording unit 3, and a discharge unit 4 for the printed recording papers such that the units 2, 3, and 4 are sequentially stacked in a vertical direction. The paper feed unit 2 for the recording papers has a paper feed cassette 201, a paper separating and feeding roller 202, and a separating pad 203. The paper feed cassette 201 can accommodate a plurality of stacked recording papers, and can be removably inserted into the device main body 1. The paper separating and feeding roller 202 is arranged at a front end portion in a paper feeding direction of the paper feed cassette 201. The separating pad 203 elastically makes contact with a circumferential surface of the paper separating and feeding roller 202. A plurality of cassettes similar to the paper feed cassette 201 may be stacked thereunder. An optional cassette (not illustrated) may also be provided.

The image recording unit 3 includes a process portion and a fuser 11 arranged at a downstream side of the process portion. The process portion includes a photoconductive drum 5. A corona charger 6, an exposing unit 7 having a Light Emitting Diode (LED), a developing device 8, a transfer roller (a transfer device) 9, and a transfer residual toner cleaning device 10 are arranged in this order around the photoconductive drum 5. Excluding the exposing unit 7 and the transfer roller 9, the process portion is provided as a process unit including a drum unit 50 and a developing device unit 80. The drum unit 50 collectively includes the photoconductive drum 5, the charger 6, and the transfer residual toner cleaning device 10. The developing device unit 80 collectively includes a developing device housing 81, agitating and transporting screws 82, 83, a supply paddle 84, and a developing roller 85. The drum unit 50 and the developing device unit 80 can be removably inserted into the device main body 1 from a front surface side of the device main body 1 separately or under a state in which the units 50 and 80 are combined by some joining member. The entire process portion excluding the exposing unit 7 and the transfer roller 9 may be collectively provided as a unitary process unit. The process unit can be exchanged as a consumable unit with a new unit if required. The front surface side of the device main body 1 refers to a front side in FIG. 1. The paper feed cassette 201 can be removably inserted into the device main body 1 from the front surface side.

The developing device unit 80 is a developing device which uses a developer including two components. The developing device housing 81 is preferably formed by resin molding and is also used as a developer container. Toner and carrier are contained in the developing device housing 81. The two mutually parallel agitating and transporting screws 82 and 83 agitate and transport the toner. The supply paddle 84 supplies the biased developing roller 85 with the developer. A magnetic sensor 86 is provided on an outer surface of the developing device housing 81. The magnetic sensor 86 detects a toner concentration (mixture ratio of the toner and the carrier) inside the developing device housing 81. A toner container 12 and a toner supplying hopper 13 defining a toner containing portion are arranged at a position that is spaced apart from the developing device unit 80. When the magnetic sensor 86 detects that the toner concentration inside the developing device housing 81 is decreased, toner is supplied from the toner hopper 13 into the developing device housing 81 via a screw conveyor (a pipe screw) 14. An agitator 121 and a toner feeding screw 122 that supplies the toner hopper 13 with the toner are provided in the toner container 12.

The toner container 12 is integrated with a waste toner container 15 as the toner containing portion. The toner container 12, as described below, is provided as a toner cartridge 16 that can be removably inserted into the device main body 1. A screw conveyor 17 is connected to the waste toner container 15. The waste toner removed and collected by the cleaning device 10 is sequentially transported and transferred to the screw conveyor 17. A toner transporting mechanism is established when the developing device unit (process unit) 80 including the developing device 8, the drum unit (process unit) 50, the toner containing portions 12, 13, and 15 are connected. The toner transporting mechanism will be described in detail below.

A switching gate 41, a discharge roller pair 42, and a discharge tray 43 are arranged at a downstream side of the fuser 11. The switching gate 41, the discharge roller pair 42, and the discharge tray 43 define the discharge unit 4. A resist roller pair 18 is arranged near an upstream side of the process portion. The recording papers (papers) are separated and fed one sheet at a time from the paper feed cassette 201 by the paper separating and feeding roller 202 and the separating pad 203. The recording paper is resisted by the resist roller pair 18 and introduced into a nip portion between the photoconductive drum 5 and the transfer roller 9. The photoconductive drum 5 rotates in a direction indicated by an arrow in FIG. 1, and a surface of the photoconductive drum 5 is uniformly negatively charged by the charger 6. An optical image based on image information is irradiated on the surface of the photoconductive drum 5 by the exposing unit 7. Thus, an electrostatic latent image is formed on the surface of the photoconductive drum 5. According to characteristics of the photoconductor on the surface of the photoconductive drum 5, an electric potential of the irradiated portion changes while an electric potential of other portions is maintained, and thus, the electrostatic latent image is formed.

The electrostatic latent image is sequentially developed by the biased developing device 8, and a toner image reaches the nip portion between the photoconductive drum 5 and the transfer roller 9. During this developing process, on the portion where the electric potential has been changed by light irradiation, the toner is adhered to the photoconductive drum 5 to form a black portion due to a potential difference between the developing device 8 and the electrostatic latent image. The toner is not adhered to the other portion, where a white portion is formed. As a whole, a black and white toner image based on the image information is formed. The resist roller pair 18 is resist-controlled, and then, rotated such that the recording paper is introduced into the nip portion in synchronism with the toner image on the surface of the photoconductive drum 5.

The transfer roller 9 is biased and paired with the photoconductive drum 5. The transfer roller 9 nips and transports the recording paper while being rotated in a direction indicated by an arrow in FIG. 1 (in a width direction of the photoconductive drum 5). At this time, the toner image on the surface of the photoconductive drum 5 is transferred onto the recording paper. The residual toner on the surface of the photoconductive drum 5 is removed and collected by the cleaning device 10. The recording paper on which the toner image has been transferred is introduced into the fuser 11. After the toner image is fixed as a permanent image on the recording paper, the recording paper pushes up the switching gate 41 and is discharged onto the discharge tray 43 via the discharge roller pair 42. This series of the paper feeding and transporting process is carried out along a main feeding path P. The main feeding path P rises substantially vertically (substantially perpendicularly) immediately above the paper feed cassette 201, and completes a U-turn at the discharge roller pair 42 in a direction that is substantially 180 degrees opposite from a direction in which the main feeding path P extends from the paper feed cassette 201. Such a layout structure reduces the size of the image forming device as a whole.

The image forming device 100 illustrated in the drawings includes a duplex printing function. A reverse feeding path P1 is provided such that the reverse feeding path P1 circulates from a position where the switching gate 41 is arranged at an upstream side of the resist roller pair 18 in the main feeding path P, and joins the main feeding path P. The discharge roller pair 42 can rotate in both directions. Transportation roller pairs 19 and 20 are provided in the reverse feeding path P1. When performing a duplex printing, after one side of the recording paper is printed as described above, the recording paper is transported along the main feeding path P, and a trailing edge of the recording paper reaches the discharge roller pair 42. Then, the discharge roller pair 42 stops once and nips the trailing edge of the recording paper. Next, the discharge roller pair 42 rotates reversely, and the recording paper, with the trailing edge thereof ahead, is transported through the reverse feeding path P1 by the transportation roller pairs 19 and 20. The recording paper then joins the main feeding path P and reaches the resist roller pair 18. The recording paper is resisted by the resist roller pair 18, and again introduced into the nip portion between the photoconductive drum 5 and the transfer roller 9, where a reverse side of the recording paper is printed. After both sides of the recording paper are printed, the recording paper is transported along the main feeding path P and discharged onto the discharge tray 43 as described above.

The image forming device 100 illustrated in the drawings further includes a manual paper feeding function. A manual paper feeding tray 21, which can be opened and closed vertically, is provided on a side portion of the device main body 1. When not using the manual paper feeding tray 21, the manual paper feeding tray 21 is closed as illustrated by double-dashed lines in FIG. 1. By operating a gripper 211, the manual paper feeding tray 21 can be opened and closed. At a front end portion of the manual paper feeding tray 21, a manual paper separating and feeding roller 212 and a separating pad 213 elastically make contact with each other. A manual feeding path P2, which joins the main feeding path P, is arranged at a further downstream side.

When performing an image printing using the manual paper feeding tray 21, the gripper 211 is operated to open the manual paper feeding tray 21. The recording papers are placed on the manual paper feeding tray 21. After a start operation is performed, the manual paper separating and feeding roller 212 is operated. The recording papers on the manual paper feeding tray 21 are separated and fed one sheet at a time by the manual paper separating and feeding roller 212 and the separating pad 213. The recording paper is transported through the manual feeding path P2, and joins the main feeding path P. Then, the recording paper is resisted by the resist roller pair 18 and introduced into the nip portion between the photoconductive drum 5 and the transfer roller 9, where the printing is performed. When performing the duplex printing on a manually fed recording paper, the recording paper is transported by the reversely rotating discharge roller pair 42 through the reverse feeding path P1. Then, as described above, the reverse side of the recording paper is printed. After the printing is completed, the recording paper is discharged onto the discharge tray 43 by the discharge roller pair 42.

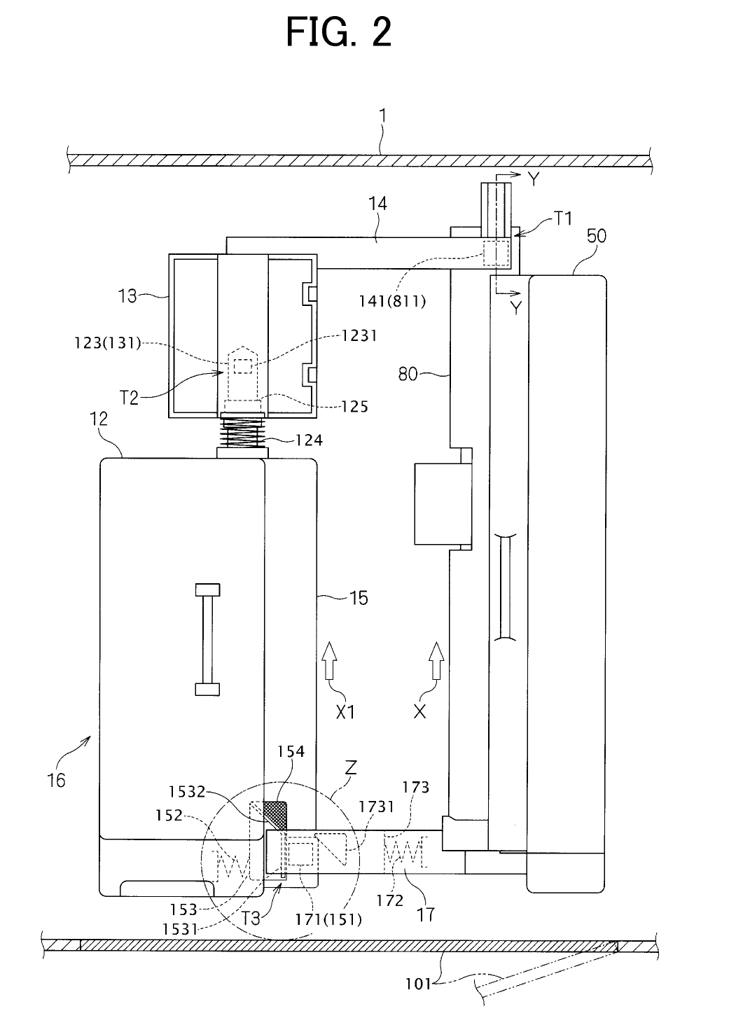

Next, a description will be made of the toner transporting mechanism. In FIG. 2, the toner hopper 13 and the toner supplying screw conveyor 14 are fixedly arranged on an inner side of the device main body 1 (an upper side in FIG. 2). The toner supplying screw conveyor 14 is connected to a discharging side of the toner hopper 13. The drum unit 50 and the developing device unit 80 as the process unit can be removably inserted into the device main body 1 under a state in which the drum unit 50 and the developing device unit 80 are vertically connected to each other. Thus, the process unit can be inserted into the device main body 1 from a front side of the device main body 1 (a lower side in FIG. 2) along a direction “X” indicated by an outlined arrow in FIG. 2. By inserting the process unit, a toner receiving port 811 of the developing device housing 81 and a toner supplying port 141 of the screw conveyor 14 are connected. Thus, a first toner receiving/supplying portion T1 is established.

The toner cartridge 16, in which the toner container 12 and the waste toner container 15 are integrally provided, can also be removably inserted into the device main body 1. The toner cartridge 16 can be inserted from the front side of the device main body 1 (the lower side in FIG. 2) along a direction “X1” indicated by an outlined arrow in FIG. 2. The directions “X” and “X1” indicated by the outlined arrows are the same direction. By inserting the toner cartridge 16, a cylindrical toner supplying tube 123 and a toner receiving portion 131 of the toner hopper 13 are connected. Thus, a second toner receiving/supplying portion T2 is established. The toner supplying tube 123 protrudes at a front end portion of the toner container 12. Upon insertion, a waste toner discharging port 171 of the screw conveyor 17 connected to the cleaning device 10 (refer to FIG. 1) is connected to a waste toner receiving port 151 of the waste toner container 15. Thus, a third toner receiving/supplying portion T3 is established. By the thus connected toner receiving/supplying portions T1, T2, and T3, the supplied toner transporting mechanism from the toner container 12 to the developing device housing 81 and the waste toner transporting mechanism from the cleaning device 10 to the waste toner container 15 are respectively established. The process units 50, 80, and the toner cartridge 16 can be inserted and removed from the front surface side of the device main body 1 under a state in which an opening/closing door 101 arranged on the front surface side of the device main body 1 is open.

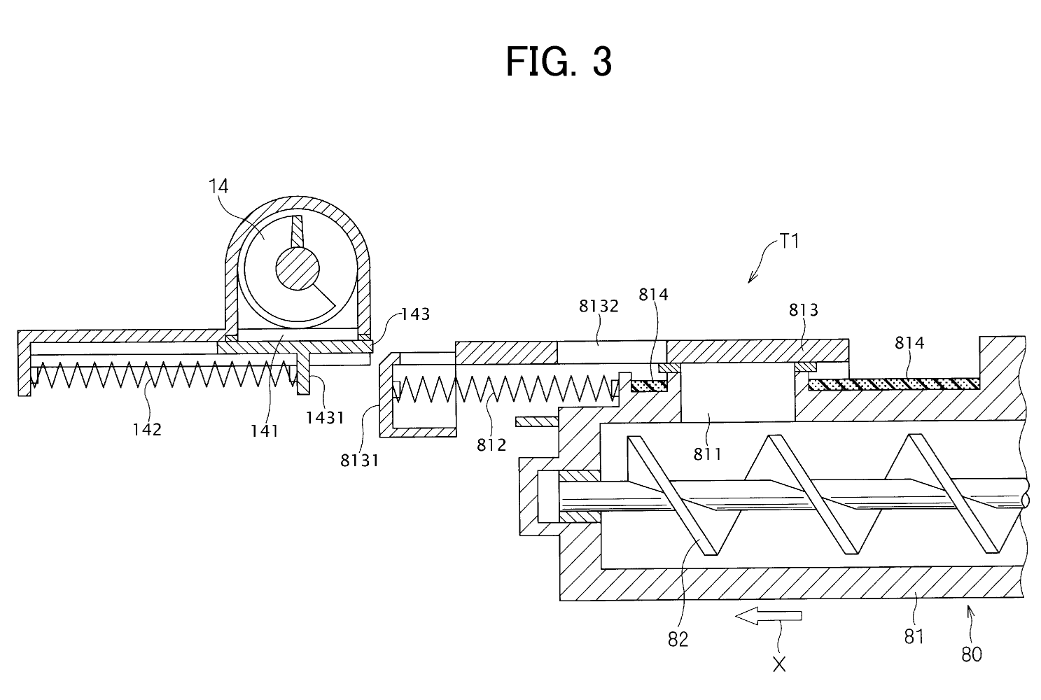

FIG. 3 is an enlarged cross sectional view taken along line Y-Y in FIG. 2, illustrating an adjacent portion of the first toner receiving/supplying portion T1. FIG. 3 illustrates a state in which the first toner receiving/supplying portion T1 has not been connected. An end portion at an upstream side of the agitating and transporting screw 82 of the developing device unit 80 is positioned directly below the toner receiving port 811 of the developing device housing 81. An upper-surface open portion of the toner receiving port 811 is closed by a shutter 813. The shutter 813 is elastically urged by a helical compression spring 812 in a direction “X” indicated by an outlined arrow in FIG. 3. The toner supplying port 141 is open in a direction that is perpendicular to the direction “X” at a lower surface on a leading end side of the screw conveyor 14 that extends from the toner hopper 13. The toner supplying port 141 is closed by a shutter 143. The shutter 143 is elastically urged by a helical compression spring 142 in a direction against the direction “X”. A spring force of the helical compression spring 142 of the screw conveyor 14 is greater than a spring force of the helical compression spring 812 of the developing device housing 81.

The first toner receiving/supplying portion T1 is connected as described below. When the developing device unit 80 along with the drum unit 50 is inserted along the direction “X” indicated by the outlined arrow into a prescribed position in the device main body 1, a front end portion 8131 of the shutter 813 makes contact with an action portion 1431. The action portion 1431 extends downwards from the shutter 143 of the screw conveyor 14. When the developing device unit 80 is further inserted, due to a magnitude correlation between the spring force of the helical compression spring 142 and the spring force of the helical compression spring 812, the helical compression spring 812 is compressed against its own elastic force. Then, the shutter 813 moves backward in a direction opposite the direction “X” with respect to the developing device housing 81. As a result, an open portion 8132 of the shutter 813 is moved to the toner receiving port 811, and thus, the toner receiving port 811 is opened. Under the above-described state, a rear end of the shutter 813 makes contact with the developing device housing 81, and the shutter 813 is stopped from moving further. When the developing device unit 80 is inserted further, the helical compression spring 142 is compressed against its own elastic force, and the shutter 143 moves backward. Accordingly, the toner supplying port 141 of the screw conveyor 14, the open portion 8132 of the shutter 813, and the toner receiving port 811 of the developing device housing 81 are aligned. Thus, the first toner receiving/supplying portion T1 is established. When the developing device unit 80 is removed in the direction opposite to the direction “X”, the toner supplying port 141 and the toner receiving port 811 are respectively closed by the shutters 143 and 813 with each biasing elastic force of the helical compression springs 142 and 812.

In a connecting and disconnecting operation of the toner receiving/supplying portion T1 described above, along with the movement of the shutters 143 and 813, it is unavoidable that some amount of the adhered toner leaks to the outside. Since the leaked toner accumulates around the toner receiving/supplying portion T1, the accumulated toner is stirred up and scattered by oscillations and impacts occurred upon the above-described connecting and disconnecting operation. At the first toner receiving/supplying portion T1, a porous member (a trapping member) 814 is attached to a surface of the developing device housing 81, in the vicinity of the toner receiving port 811. The porous member 814 is preferably composed of urethane foam, etc. The porous member 814 includes a plurality of micro cells therein. Therefore, toner particles that have been leaked and scattered upon the connecting and disconnecting operations can be trapped and fixed inside the micro cells. Thus, the toner stirred up by the oscillations and impacts can be reduced.

As illustrated in FIG. 2, the second toner receiving/supplying portion T2 is established when the cylindrical toner supplying tube 123 and the toner receiving portion 131 of the toner hopper 13 are connected. The toner supplying tube 123 protrudes at a front end portion in the direction “X1” of the toner container 12 that defines the toner cartridge 16. A cylindrical shutter 125 is located at an outer circumference of the toner supplying tube 123. The shutter 125 is elastically urged in the direction “X” by a helical compression spring 124. When inserting and connecting the toner supplying tube 123 to the toner receiving portion 131 of the toner hopper 13, the shutter 125 is moved backward along with compression of the helical compression spring 124 against its own elastic force. Thus, a supplying port 1231 of the toner supplying tube 123 is opened, and the toner supplying tube 123 and the toner receiving portion 131 are connected. Accordingly, the second toner receiving/supplying portion T2 is established. A front end portion of the toner feeding screw 122 (refer to FIG. 1) provided in the toner container 12 reaches inside the toner supplying tube 123. By operating the feeding screw 122, the toner in the toner container 12 is supplied to the toner hopper 13.

The toner hopper 13 temporarily stores the toner supplied from the toner container 12. When the magnetic sensor 86 of the developing device 8 sends a signal of toner shortage, the screw conveyor 14 connected to the toner hopper 13 is operated. The toner is supplied from the first toner receiving/supplying portion T1 into the developing device housing 81. In order to constantly store a prescribed amount of toner in the toner hopper 13, operation control of the feeding screw 122 is performed based on a detection signal from a sensor (not illustrated) provided in the toner hopper 13. The prescribed amount of toner stored in the toner hopper 13 can be set to an amount sufficient to continue a printing operation, for example, until the toner cartridge 16 is changed to a new one when there is no toner in the toner container 12. In a preferred embodiment of the present invention, since an amount of toner leakage at the second toner receiving/supplying portion T2 is small due to a connection structure of the second toner receiving/supplying portion T2, the toner trapping member described above is not particularly required to be attached to the toner receiving/supplying portion T2. However, if the toner leaks due to features of the connection structure, the toner trapping member described above may also be attached in the vicinity of a toner leaking portion.

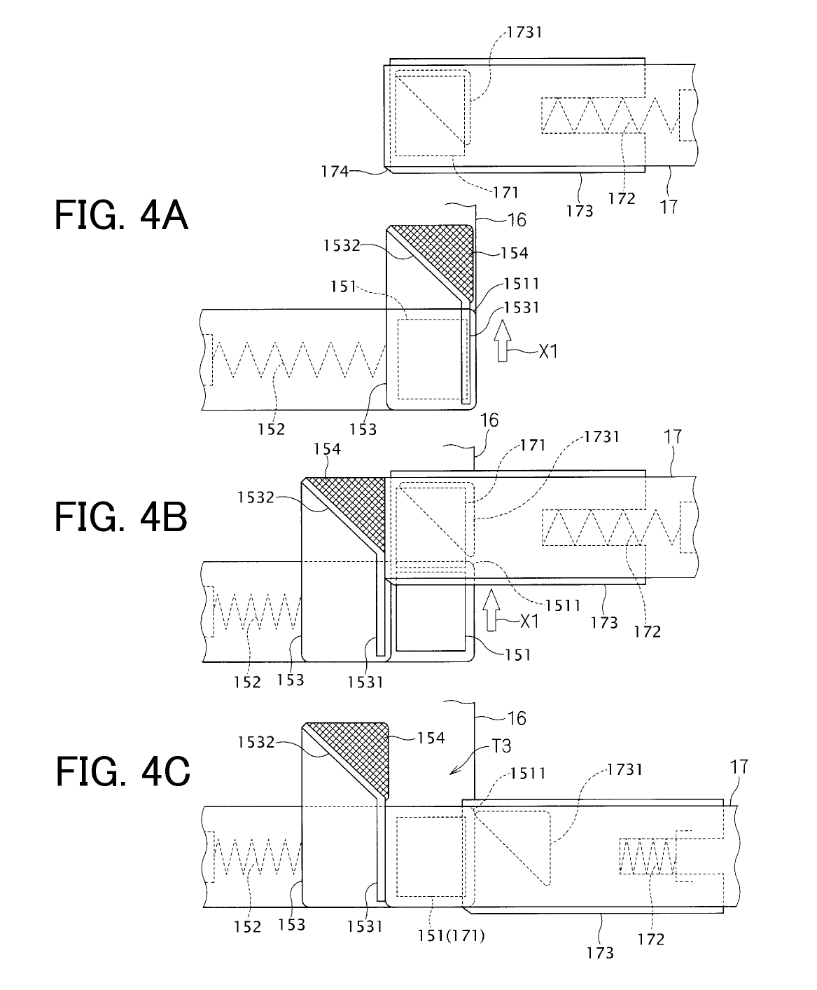

FIGS. 4A, 4B, and 4C are schematic plan views illustrating a process in which the third toner receiving/supplying portion T3 is established. The toner cartridge 16 is inserted along a direction “X1” indicated by an outlined arrow into the device main body 1 in which the developing device unit 80 and the drum unit 50 have been inserted and set to a prescribed position. FIG. 4A illustrates a state in which the third toner receiving/supplying portion T3 has not been established. An end side of the waste toner screw conveyor 17 is connected to the cleaning device 10 of the drum unit 50. The waste toner discharging port 171, which is open downwards, is arranged at the end side of the waste toner transporting screw conveyor 17, which extends from a rear end of the drum unit 50 in a perpendicular direction. The waste toner discharging port 171 is closed by a shutter 173. The shutter 173 is elastically urged by a helical compression spring 172 in a transporting direction. A cam member 1731 is fixed at a lower surface of the shutter 173 and includes a cam surface arranged approximately 45 degrees with respect to the transporting direction. The waste toner receiving port 151 of the waste toner container 15 is open upwards, and closed by a shutter 153 that is elastically urged by the helical compression spring 152 in a direction opposite to the transporting direction. A first cam piece that is parallel to the direction “X1”, and a second cam piece that is coupled at an end side of the first cam piece and arranged approximately 45 degrees with respect to the direction “X1”, integrally stand and are fixed on an upper surface of the shutter 153.

From a state illustrated in FIG. 4A, when the toner cartridge 16 is inserted in the direction “X1” into the device main body 1 (refer to FIGS. 1 and 2), a cam surface of the second cam piece 1532 makes contact with an end corner portion 174 of the waste toner transporting screw conveyor 17. When an inserting operation of the toner cartridge 16 is continued, by a cam action of the second cam piece 1532, the shutter 153 is moved backward against an elastic force of the helical compression spring 152. As illustrated in FIG. 4B, the waste toner receiving port 151 is opened, and the end portion of the waste toner transporting screw conveyor 17 is positioned along the cam surface of the first cam piece 1531. When inserting the toner cartridge 16 further, while the cam surface of the first cam piece 1531 is positioned along the end portion of the waste toner transporting screw conveyor 17, the cam surface of the cam member 1731 of the waste toner transporting screw conveyor 17 makes contact with a peripheral corner portion 1511 of the waste toner receiving port 151. By the cam action of the cam member 1731, the shutter 173 is moved backward against an elastic force of the helical compression spring 172, and thus, the waste toner discharging port 171 is opened. Accordingly, the waste toner discharging port 171 and the waste toner receiving port 151 are aligned. Thus, a connecting status of the third toner receiving/supplying portion T3 is established. At this time, the second toner receiving/supplying portion T2 is also established.

As described above, by establishing the third toner receiving/supplying portion T3, the transfer residual toner removed and collected by the cleaning device 10 is sequentially accommodated from the waste toner transporting screw conveyor 17 into the waste toner container 15. When the toner cartridge 16 is removed in the direction opposite to the direction “X1”, the cam pieces 1531, 1532, and the cam member 1731 are released, and the waste toner receiving port 151 and the waste toner discharging port 171 are respectively closed by the shutters 153 and 173 with each urging elastic force of the helical compression springs 152 and 172.

In a connecting and disconnecting operation of the toner receiving/supplying portion T3, along with the movement of the shutters 153 and 173, it is unavoidable that some amount of the adhered toner leaks to the outside. Since the leaked toner accumulates around the toner receiving/supplying portion T3, the accumulated toner is stirred up and scattered by the oscillations and impacts occurred upon the connecting and disconnecting operations. At the third toner receiving/supplying portion T3, the waste toner particularly easily accumulates on an upper surface of the shutter 153. Accordingly, as illustrated by cross-hatching, the porous member (the trapping member) 154 composed of urethane foam, etc. is attached to an upper portion of the constantly exposed shutter 153. The porous member 154 includes a plurality of micro cells therein. The toner particles that are leaked upon the connecting and disconnecting operations can be trapped and fixed inside the micro cells. Thus, the toner stirred up by the oscillations and impacts can be reduced. Particularly, the third toner receiving/supplying portion T3 is arranged on a front surface side of the device main body 1, that is, on a side on which a user stands. Therefore, when inserting and removing the process units 50, 80, and/or the toner cartridge 16, since the units 50, 80, and the toner cartridge 16 are positioned close to the user, if the toner scatters from the above-described portion, the toner can stain hands and clothing of the user. However, since the leaked toner can be effectively trapped by the porous member 154, such concerns can be cleared.

In the preferred embodiments of the present invention, the developing device using a two-component developer has been described as an example. However, the present invention is not limited to the above-described case, and can be applied to a case in which the developing device using a one-component developer is used. Moreover, in a case in which a cleanerless system is used, the waste toner transporting mechanism is not provided. Further, an attaching portion of the porous member (trapping member) 814 and 154 are not limited to the above-described examples. The toner can be prevented from scattering by attaching the porous member to a portion adjacent to the toner receiving/supplying portion, and to a portion where the leaked toner can easily accumulate. Furthermore, the examples have been described in which the process units 50, 80, and the toner cartridge 16 are inserted from the front surface side of the device main body 1. However, the present invention can be applied to a case in which the units 50, 80, and the toner cartridge 16 are inserted from a right or left surface side, or a rear side.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image forming device comprising:
a process unit;
a toner containing portion arranged to be connected to the process unit so as to define a toner transporting mechanism, the toner transporting mechanism including a toner receiving/supplying portion having a toner receiving port and a toner supplying port such that the toner receiving port and the toner supplying port can be removably connected to each other; and
a trapping member attached to a surface adjacent to the toner receiving/supplying portion and arranged to trap leaked toner.

2. The image forming device according to claim 1, further comprising a shutter arranged on each corresponding portion of the toner receiving/supplying portion in the toner transporting mechanism such that the shutter can be opened when the toner receiving port and the toner supplying port are connected.

3. The image forming device according to claim 1, wherein the trapping member includes a porous member having a plurality of micro cells capable of absorbing toner particles.

4. The image forming device according to claim 1, wherein the process unit is arranged to be removably inserted into a device main body from a side portion of the device main body; and
the toner receiving/supplying portion is positioned at a front side in an inserting direction of the process unit.

5. The image forming device according to claim 1, wherein the toner containing portion is arranged to be removably inserted into a device main body from a side portion of the device main body; and
the toner receiving/supplying portion is positioned at a front side in an inserting direction of the toner containing portion.

6. The image forming device according to claim 1, wherein the process unit and the toner containing portion are arranged to be removably inserted into a device main body from a side portion of the device main body; and
the toner receiving/supplying portion is positioned on a front side in an inserting direction of the process unit and the toner containing portion.

7. The image forming device according to claim 3, wherein the process unit includes a developing device unit having a developing device using a two-component developer containing toner and carrier; and
the toner containing portion includes a toner container arranged to contain the toner to be supplied to the developing device.

8. The image forming device according to claim 3, wherein the process unit includes a developing device unit having a developing device using a two-component developer containing toner and carrier; and
the toner containing portion includes a toner hopper arranged to temporarily store the toner to be supplied to the developing device.

9. The image forming device according to claim 8, wherein the developing device includes a developing device housing having a toner receiving portion;
a screw conveyor including a toner supplying port connected to a discharging side of the toner hopper; and
when the developing device unit is inserted into a device main body, the toner receiving port and the toner supplying port are connected to establish the toner receiving/supplying portion.

10. The image forming device according to claim 3, wherein the process unit includes a drum unit having a cleaning device arranged to remove and collect residual toner as waste toner; and
the toner containing portion includes a waste toner container arranged to contain the waste toner.

11. The image forming device according to claim 10, wherein the cleaning device includes a waste toner transporting screw conveyor having a waste toner discharging port;
the waste toner container includes a waste toner receiving port; and
when the waste toner container is inserted into a device main body, the waste toner receiving port and the waste toner discharging port are connected to establish the toner receiving/supplying portion.

12. The image forming device according to claim 3, wherein the process unit includes a developing device unit having a developing device using a two-component developer containing toner and carrier, the process unit includes a drum unit having a cleaning device arranged to remove and collect residual toner as waste toner;
the toner containing portion includes a toner container arranged to contain the toner to be supplied to the developing device and a waste toner container arranged to contain the waste toner; and
the toner container and the waste toner container are integral.
